(19) United States
(12) Patent Application Publication
(10) Pub. No.: US 2003/0219116 A1
(43) Pub. Date: Nov. 27, 2003

(54) Sanitary cover for a telephone handset

(76) Inventor: Melvin Hudgins, Queens Village, NY (US)

Correspondence Address: OSTROLENK FABER GERB & SOFFEN, 1180 AVENUE OF THE AMERICAS, NEW YORK, NY, 100368403

(21) Appl. No.: 10/156,273

(22) Filed: May 24, 2002

(51) Int. Cl. H04M 1/00; H04M 9/00

(52) U.S. Cl. 379/433.11; 379/451

(57) ABSTRACT

A sanitary cover being easily affixed to the microphone or speaker portions of a telephone handset for preventing transmission of microscopic particles present on the handset therethrough. The sanitary cover is made of a single piece of material, such as a cloth, that is essentially flat and round and the peripheral edge of which is underfolded and a resilient rubber is sewn therein to convert the flat piece of material into a dome or cup-shaped piece, the peripheral edge of which is inwardly gathered and sufficiently resilient and so sized as to firmly hold onto the microphone or speaker portion of the telephone handset. The material may be impregnated with a sanitary or disinfectant material or aromatic material.

### BACKGROUND OF THE INVENTION

The present invention relates generally to sanitary covers for phone handsets, and more particularly, to an easily transportable and non-burdensome device removably connected to the microphone or speaker ends of a telephone handset, to prevent the transfer of germs between successive users of the telephone handset.

Numerous sanitary covers for telephone handsets have been provided in the prior art. Such covers are used to cover at least the microphone and speaker portions of the telephone handset to prevent the transmission of germs, bacteria and the like from one user to a subsequent user of the telephone. For example, U.S. Pat. No. 6,314,185 B1 describes a sanitary cover for a telephone handset of the above type and cites therein even earlier examples thereof, as described in U.S. Pat. Nos. 4,546,217, 4,964,161, 5,054,063 and 5,396,557.

Numerous other patents directed to the general subject of sanitary devices for use with telephones have been disclosed over the years, including U.S. Pat. Nos. 5,559,882, 5,501,329, 4,852,163, 4,570,038, 5,682,424, 4,486,628, 4,819,265, 4,582,966, 4,546,217, 3,962,555, 5,938,069, 5,930,356, 5,396,557, 5,123,044, 6,301,359 B1, 6,256,388 B1, 6,001,066, 6,186,959 B1, 6,125,180, 5,878,593, 5,039,865 and 5,054,063. The contents of all of the aforementioned prior art patents are incorporated by reference herein.

There is little doubt that the general subject of providing sanitary, as well as disposable, covers for telephone handsets has been explored extensively in the prior art. Nevertheless, it is a general objective of the present invention to provide further embodiments of such sanitary telephone covers having even greater simplicity, ease of use, disposability, and cost advantages.

### SUMMARY OF THE INVENTION

Accordingly, it is an object of the present invention to provide a further improved disposable sanitary telephone cover that is less expensive, easier to use, less difficult to carry around and still effective to provide protection for persons who work in offices and institutions where numerous people need to have access to the same telephone set and are particularly concerned about the transfer of germs and bacteria, e.g., for use in hospitals, prisons, schools, public phones, and the like.

The foregoing and other objects of the invention are realized with a sound-permeable disposable sanitary telephone cover easily attachable to the speaker portion of a telephone handset for protecting the speaker from contacting any surfaces which might be exposed to bacteria and other contagious and infectious agents carried by the telephone.

The invention comprises a sanitary cover being easily affixed to the microphone or speaker portions of a telephone handset for preventing transmission of microscopic particles present on the handset therethrough. The sanitary cover is made of a single piece of material, such as a cloth that is essentially flat and round and the peripheral edge of which is inwardly folded and a resilient rubber is sewn into the folded portion to convert the flat piece of material into a dome or cup-shaped piece, the peripheral edge of which is inwardly gathered and sufficiently resilient and so sized as to firmly hold onto the protruding microphone or speaker portion of the telephone handset. The material may be impregnated with a sanitary or disinfectant or aromatic material.

Other features and advantages of the present invention will become apparent from the following description of the invention which refers to the accompanying drawings.

### BRIEF DESCRIPTION OF THE DRAWINGS

FIG. 1 is a first perspective of the sanitary cover for telephones of the present invention.

FIG. 1A illustrates a flat piece of flexible material from which the sanitary cover of FIG. 1 is constructed.

FIG. 2 is a second perspective of the sanitary cover shown in FIG. 1.

FIG. 3 is a plan view of the sanitary cover of FIG. 1 when the same has been flattened into a planer shape.

FIG. 4 is a view of the sanitary cover of FIG. 3, as seen along lines 4-4 in FIG. 3.

FIG. 5 shows a bag for carrying a plural number of the devices of FIG. 1.

FIGS. 6A, 6B and 6C show successive perspective views of a sanitary cover for telephones in accordance with a second embodiment of the present invention.

FIG. 7 shows the sanitary cover for telephones of the present invention affixed to a telephone handset.

### DETAILED DESCRIPTION OF PREFERRED EMBODIMENTS

The sanitary and disposable telephone headset speaker cover 10 of the present invention is constructed from a generally round and flexible starting material that can be made from paper-based material or from cloth or, indeed, from sterile materials such as sterile gauze that is used for cleaning and covering wounds which is sold by Johnson & Johnson. This material can be impregnated with sanitary material such as disinfectant or the like, as well as aromatic materials, to provide protection against germs, bacteria and the like, as well as to provide a pleasant, aromatic milieu to the user and a sense of protection and safety.

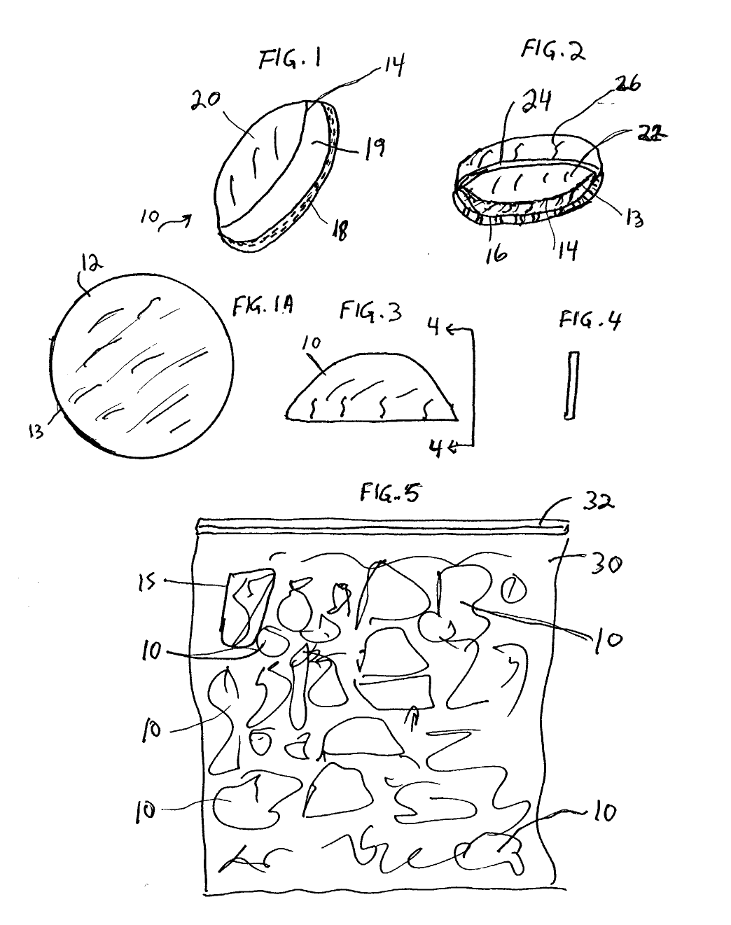

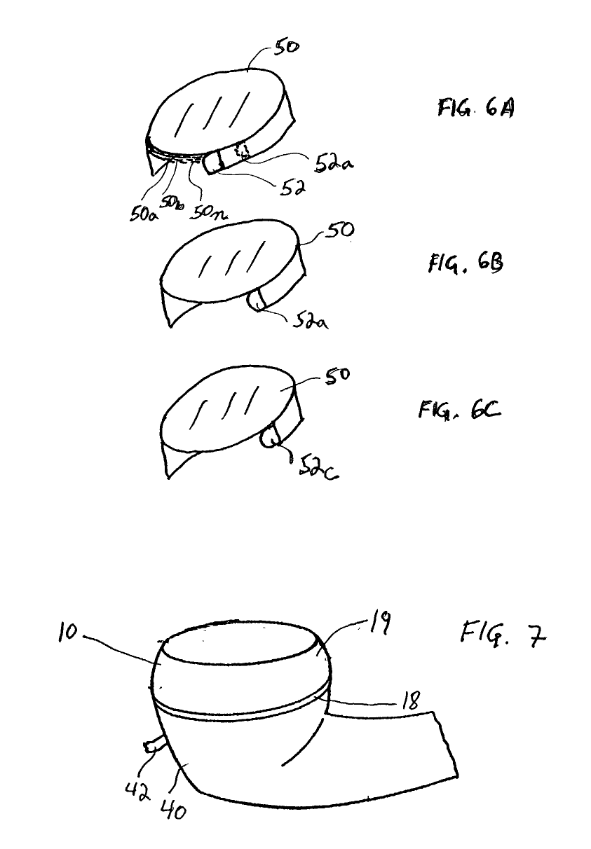

The telephone cover piece 10 of FIG. 1 is constructed by inwardly folding a section of the peripheral round edge 13 (see FIG. 1A and FIG. 2) and by crunching and gathering the material and by inserting at the fold line, a rubberized and resilient band 18 indicated in dotted lines in FIG. 1. The diameter or length of the band 18 is selected to gather the material inward, so as to create a holding power that allows the cover 10 to hold onto the microphone portion of the telephone 40, having a cord 42, all as shown in FIG. 7. By inwardly folding an amount of the material that is more than necessary for creating the channel 16 for the resilient band 18, the overall structure of the flexible material is somewhat rigidified to create a portion 19 that generally contacts the sidewalls of the microphone portion of the telephone 40. The portion 20 has only a single layer of material and faces and comes in breath contact with the mouth of the microphone user. The interior 22 is generally sized to fit the telephone.

Since the sanitary cover of the present invention is made of cloth or paper material, it can easily be flattened to assume the shape shown in FIG. 3, which is quite thin, so as to fit even in a wallet, as indicated in the view provided by FIG. 4.

In the form shown in FIG. 3, the sanitary cover can be crunched up, so that its length and height extend well less than three inches and closer to two inches in length and about an inch to an inch and one half on the height and approximately on the order of a one half centimeter in thickness.

Individual sanitary covers can be provided in their own individual sealed bags 15 and carried in one's wallet for easy use and application, not unlike carrying a sterile gauze and the like. Alternatively, and as shown in FIG. 5, a large number can be carried in a Ziploc® bag 30, which has an airtight lock 32, as shown.

The embodiments in FIGS. 6A, 6B and 6C illustrate an entirely different embodiment for a sanitary telephone cover, in which the cover consists of a plural number of covers in which the overall device comes as an assembled unit 50 comprising a plurality of individual covers 50a, 50b, 50c . . . 50n. The covers lie atop one another and affixed to one another by a very light adhesive, so that when the tab 52 of the uppermost cover 50a is grasped and lightly pulled, it peels away, exposing the underlying cover 50b, which has associated therewith, the tab 52a. The next cover has a tab 52c. Thus, when the assembly 50 is attached to a telephone, successive users merely need to grasp the tab and remove the cover used by the previous telephone user. This is intended for institutions, such as hospitals, prisons, schools and the like, to provide increased protection against infectious diseases to persons who would otherwise not wish to trouble themselves with taking their own measures to protect themselves.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A sanitary cover removably attachable to a microphone section of a telephone for preventing the transmission of microscopic particles between successive users of the telephone, said sanitary cover comprising:
a body made from a single piece, generally round, flexible material having a peripheral section that is underfolded to create a pocket, having a peripheral edge and a folded material section adjacent thereto;
a resilient member located in the pocket, the resilient member being sized to gather and reduce the peripheral size of the peripheral edge, so as to create a three-dimensional interior space in the sanitary cover that is sized to receive the microphone section of the telephone, while the resilient member functionally holds onto the microphone section, the underfolded section of the material, creating a double layer of material to create a sidewall that abuts against a sidewall portion of the microphone section of the telephone.

2. The telephone sanitary cover of claim 1, in which the material is impregnated with an anti-bacterium material.

3. The telephone sanitary cover of claim 1, in which the material is impregnated with an aromatic material.

4. The telephone sanitary cover of claim 1, in which the material of the cover is a cloth.

5. The telephone sanitary cover of claim 1, in which the material of the cover is a paper-based material.

6. The telephone sanitary cover of claim 1, in which the cover can be collapsed into an approximately half circle shape that is generally flat and has a base on the order of between two and three inches and a height of approximately one inch.

7. The telephone sanitary cover of claim 1, in which the cover is housed in a hermetically-sealed bag to maintain the sanitary condition of the cover.

8. The telephone sanitary cover of claim 1, further comprising a kit in the form of a bag with an airtight lock and providing a plurality of said telephone sanitary covers inside the bag.

9. A telephone sanitary cover removably attachable to a microphone section of a telephone for preventing the transmission of microscopic particles between successive users of the telephone, the santiary cover comprising:
a stack of a plurality of three or more stacked individual cover pieces that are adheringly connected to one another with an innermost cover piece being more tightly adhered by adhesive to the microphone section of the telephone, successive covers being adhered to one another and with each cover having a tab by which it can be grasped to pull it off the stack, so that successive users can peel away a previously used top cover piece and be provided with a fresh underlayer that has not been exposed to a prior user.

10. The telephone sanitary cover of claim 9, in which the tab of each successive piece is obscured by the cover above it, so that only the tab of the current uppermost cover piece can be grasped by the user.

11. The telephone sanitary cover of claim 9, in which the material is impregnated with an anti-bacterium material.

12. The telephone sanitary cover of claim 9, in which the material is impregnated with an aromatic material.
